(19) United States
(12) Patent Application Publication
(10) Pub. No.: US 2026/0310142 A1
(43) Pub. Date: Oct. 8, 2026

(54) METHODS AND APPARATUS TO IMPLEMENT REDUNDANT SOFTWARE-DEFINED CONTROLLERS IN CONTROL SYSTEMS

(71) Applicant: Fisher-Rosemount Systems, Inc., Round Rock, TX (US)

(72) Inventor: Michael Andrew Whitaker, Austin, TX (US)

(21) Appl. No.: 19/637,795

(22) Filed: Apr. 2, 2026

Related U.S. Application Data
(60) Provisional application No. 63/783,057, filed on Apr. 3, 2025.

(51) Int. Cl. G05B 9/03

(52) U.S. Cl. CPC G05B 9/03

(57) ABSTRACT

Systems, apparatus, articles of manufacture, and methods to implement redundant software-defined controllers in control systems are disclosed. An example apparatus includes programmable circuitry to at least one of instantiate or execute the machine readable instructions to: send a partner identifier to first and second hosts in a network; send a first command to the first host to create a first software-defined controller for a control system; and send a second command to the second host to create a second software-defined controller for the control system. The first and second software-defined controllers are to discover one another and pair with one another based on the partner identifier.

### RELATED APPLICATION

This patent claims the benefit of U.S. Provisional Patent Application No. 63/783,057, which was filed on Apr. 3, 2025. U.S. Provisional Patent Application No. 63/783,057 is hereby incorporated herein by reference in its entirety. Priority to U.S. Provisional Patent Application No. 63/783,057 is hereby claimed.

### FIELD OF THE DISCLOSURE

This disclosure relates generally to control systems and, more particularly, to methods and apparatus to implement redundant software-defined controllers in control systems.

### BACKGROUND

Process control systems typically include one or more process controllers and input/output (I/O) devices communicatively coupled to at least one host or operator workstation and to one or more field devices to control the processing of input materials to produce one or more desired output products. Frequently different controllers are physically wired with a direct link to provide redundancy, in which one controller can take over for the other in the event of some sort of failure.

### SUMMARY

An example apparatus includes interface circuitry, machine readable instructions, and programmable circuitry to at least one of instantiate or execute the machine readable instructions to send a partner identifier to first and second hosts in a network, send a first command to the first host to create a first software-defined controller for a control system, and send a second command to the second host to create a second software-defined controller for the control system, the first and second software-defined controllers to discover one another and pair with one another based on the partner identifier.

An example non-transitory machine readable storage medium includes instructions to cause programmable circuitry to at least send a partner identifier to first and second hosts in a network, send a first command to the first host to create a first software-defined controller for a control system, and send a second command to the second host to create a second software-defined controller for the control system, the first and second software-defined controllers to discover one another and pair with one another based on the partner identifier.

An example method includes sending, by executing instructions with programmable circuitry, a partner identifier to first and second hosts in a network, sending, by executing instructions with the programmable circuitry, a first command to the first host to create a first software-defined controller for a control system, and sending, by executing instructions with the programmable circuitry, a second command to the second host to create a second software-defined controller for the control system, the first and second software-defined controllers to discover one another and pair with one another based on the partner identifier.

An example apparatus includes interface circuitry, machine readable instructions, and programmable circuitry to at least one of instantiate or execute the machine readable instructions to create a first software-defined controller for a control system in response to a command from a client machine, write a partner identifier to a local filesystem of the first software-defined controller, the partner identifier received from the client machine, cause the first software-defined controller to broadcast a message including the partner identifier over a network to discover a second software-defined controller that was also provided the partner identifier from the client machine, and cause the first software-defined controller to pair with the second software-defined controller.

An example non-transitory machine readable storage medium includes instructions to cause programmable circuitry to at least create a first software-defined controller for a control system in response to a command from a client machine, write a partner identifier to a local filesystem of the first software-defined controller, the partner identifier received from the client machine, cause the first software-defined controller to broadcast a message including the partner identifier over a network to discover a second software-defined controller that was also provided the partner identifier from the client machine, and cause the first software-defined controller to pair with the second software-defined controller.

An example method includes creating a first software-defined controller for a control system in response to a command from a client machine, writing a partner identifier to a local filesystem of the first software-defined controller, the partner identifier received from the client machine, causing, by executing instructions with programmable circuitry, the first software-defined controller to broadcast a message including the partner identifier over a network to discover a second software-defined controller that was also provided the partner identifier from the client machine, and causing, by executing instructions with the programmable circuitry, the first software-defined controller to pair with the second software-defined controller.

### BRIEF DESCRIPTION OF THE DRAWINGS

FIG. 1 is a block diagram of an example environment in which an example client machine is in communication with hosts to instantiate redundant software-defined controllers in a control system.

FIG. 2 is a block diagram of the example environment of FIG. 1 in which redundant software-defined controllers discover one another based on a unique identifier assigned to both redundant software-defined controllers.

FIG. 3 is a flowchart representative of example machine-readable instructions and/or example operations that may be executed, instantiated, and/or performed by example programmable circuitry to implement the client machine of FIG. 1 to instantiate redundant software-defined controllers in one or more host(s).

FIG. 4 is a flowchart representative of example machine-readable instructions and/or example operations that may be executed, instantiated, and/or performed by example programmable circuitry to implement the hosts of FIGS. 1 and 2 to instantiate and pair redundant software-defined controllers.

FIG. 5 is a flowchart representative of example machine-readable instructions and/or example operations that may be executed, instantiated, and/or performed by example programmable circuitry to implement the client machine of FIG. 1 to update redundant software-defined controllers.

FIG. 6 is a block diagram of an example processing platform including programmable circuitry structured to execute, instantiate, and/or perform the example machine-readable instructions and/or perform the example operations of FIGS. 3-5 to implement the client machine, the hosts, and/or components thereof of FIGS. 1 and 2.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine-readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Examples disclosed herein may be used to implement redundant software-defined virtual controllers in control systems and software-defined redundancy links through which the redundant virtual controllers pair with one another and communicate. Examples disclosed herein may be implemented in distributed control systems, process control systems, industrial control systems, manufacturing control systems, and/or any other control system in which controllers are employed to monitor and/or control different aspects of such control systems.

To maintain resiliency of a distributed process control system, controllers can be set up as a redundant pair, one active and one standby. If one controller fails (e.g., due to a hardware or software failure), a switchover occurs, and the standby controller becomes the active controller. Prior solutions of providing redundant controllers employ a physical dedicated redundancy link between two separate redundant discrete controller hardware units. Communication between the active and standby controllers is maintained through this physical dedicated redundancy link in the backplane of a physical carrier device. When both controllers are plugged into the physical carrier device through respective physical connections, they can detect each other's presence and communicate. When the standby controller detects a fault or failure of the active controller via the physical dedicated redundancy link, the standby controller assumes the active role as part of a redundant failover process.

Unlike prior redundant controller techniques that use a physical dedicated redundancy link, examples disclosed herein implement software-defined controllers. Software-defined controllers disclosed herein do not employ a physical carrier device and physical dedicated redundancy link. Using examples disclosed herein, software-defined controllers can be run on one or more server(s) or host(s) and can be configured so that newly instantiated redundant software-defined controllers can autonomously find and pair with one another across a network. Further, in some examples, the pairing of redundant software-defined controllers involves automatically synchronizing their states to share their configurations to ensure both controllers have access to all process data necessary to control an associated control system. That is, although only one of the redundant software-defined controllers is actively running at any given point in time (e.g., the active controller), the other controller (e.g., the standby controller) is able to immediately take over in the event the first controller fails for some reason. In other words, examples disclosed herein do not merely provide stateless redundancy. Rather, examples disclosed herein provide stateful redundancy in which the standby controller is a resource dedicated as a backup specific to the active controller by maintaining the same state as the active controller.

Unlike a prior controller hardware unit that is a piece of discrete physical equipment, software-defined controllers disclosed herein are instantiations of software programs running on one or more hosts to carry out the functionality of discrete controller hardware units. Software-defined controllers disclosed herein can be instantiated on underlying hardware hosts without needing to be indefinitely tied to such underlying hardware. That is, a software-defined controller implemented in accordance with teachings of this disclosure can be instantiated on one hardware host, subsequently deleted, and instantiated on the same or a different hardware host.

During an instantiation phase, redundant software-defined controllers are instantiated on respective virtual machines (VMs) running on corresponding hardware hosts. The software-defined controllers receive a same unique partner identifier (ID) upon creation from client software that manages controller hosts. This unique partner ID is written to the software-defined controllers over a VMBus so that they can find one another as redundant partner pairs over a network.

When the redundant software-defined controllers find one another during a pairing phase, they create a software-defined redundancy link between one another. Through the software-defined redundancy link, the redundant software-defined controllers can monitor one another for signs of faulty behavior or failure.

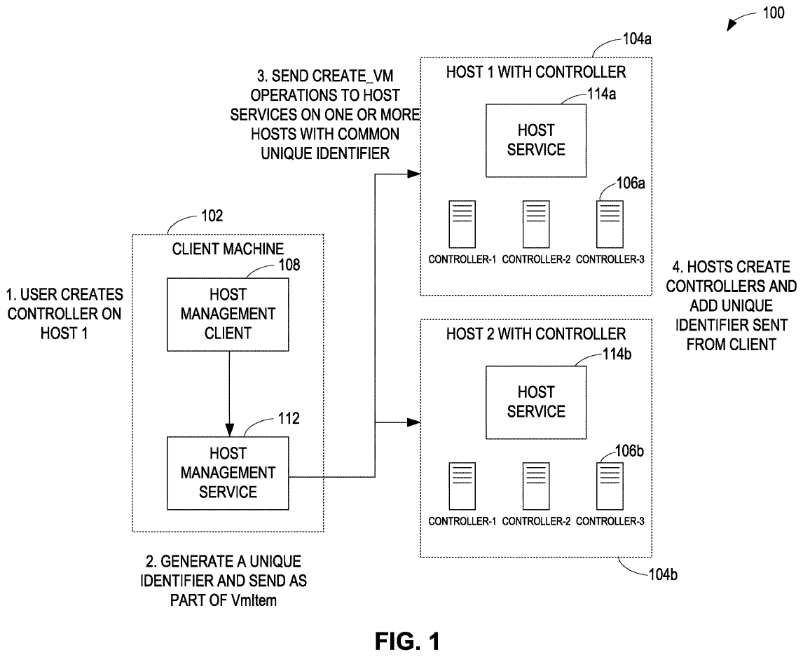

FIG. 1 is a block diagram of an example environment 100 in which an example client machine 102 is in communication with hosts 104a, 104b to instantiate redundant software-defined controllers 106a, 106b (e.g., virtual controllers) in a control system. The client machine 102 can be any suitable computing device that can be used by a user to instantiate and manage the software-defined controllers 106a, b. For example, the client machine 102 may be a workstation, a personal computer, a tablet computing device, a mobile phone, a VM, a cloud-based desktop-as-a-service instantiation, etc. The hosts 104a, b can be any suitable computing device that can be used to run machine-executable instructions (e.g., programs) that instantiate the software-defined controllers 106a, b. For example, the hosts 104a, b can be servers, personal computers, etc.

In the example of FIG. 1, the client machine 102 includes an example host management client 108 and an example host management service 112. Also, in the example of FIG. 1, each host 104a,b includes a corresponding host service 114a, 114b. The host management service 112 and the host services 114a, b may be implemented using any suitable host management software to, for example, manage VMs. For example, the host services 114a, b interact with a hyper-V application programming interface (API) of a hypervisor running on the hosts 104a, b to instantiate and manage VMs on which the software-defined controllers 106a, b are instantiated. In some examples, the host management service 112 and the host services 114a, b are implemented using a DeltaV™ Virtual Studio (DVS) management software by Emerson Electric Co. of the United States of America. In other examples, the host management service 112 and the host services 114a, b are implemented using Linux-based software or software of any other suitable operating system.

The host management client 108 generates and manages a user interface to present information to a user via a display and to receive user input from the user. The host management service 112 processes status information of software-defined controllers deployed across a network and provides such status information to the host management client 108 for presentation to users. The host management service 112 also receives user requests from the host management client 108 to, for example, deploy/instantiate software-defined controllers, update software-defined controllers, manage software-defined controllers, and terminate/delete software-defined controllers. For example, the client machine 102 can run an algorithm to identify hosts having the most available resources to accommodate new software-defined controllers and can present recommended hosts based on that analysis via a user interface (e.g., a graphical user interface (GUI)). A user can then select which host hardware to use to instantiate new software-defined controllers.

The host management service 112 deploys the redundant software-defined controllers 106a, b in corresponding ones of the hosts 104a, b so that the redundant software-defined controllers 106a, b autonomously search for one another across a network and autonomously pair up with one another without using a physical dedicated redundancy link in the backplane of a physical carrier device and without intervention of the host management service 112 to perform such discovery and pairing processes. The host management client 108, which manages the hosts 104a, b where the software-defined controllers 106a, b are deployed, generates a unique partner ID (e.g., a globally unique ID (GUID)). The host management client 108 creates this unique partner ID during a controller instantiation phase when the software-defined controllers 106a, b are first created or when a new software-defined controller partner is assigned if a previous software-defined controller partner becomes unavailable. For example, the host management client 108 can generate the unique partner ID based on operating system (OS) libraries (e.g., Microsoft Windows® OS libraries). The host management client 108 sends a create VM request (e.g., a create_VM command) that contains the unique partner ID as metadata to each of the host services 114a, b running on the hosts 104a, b. The host services 114a, b receive corresponding ones of the create VM requests and create new VMs in which the software-defined controllers 106a, b will run.

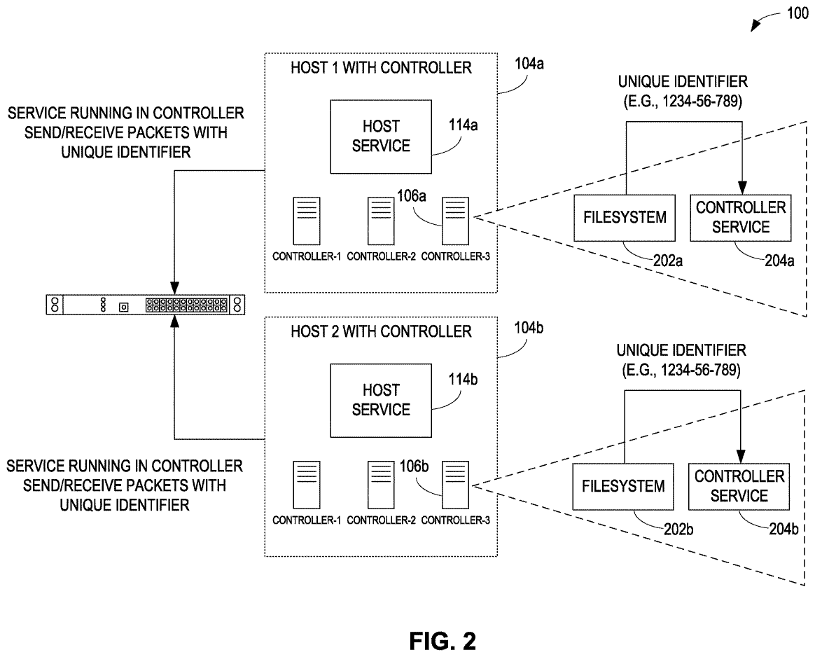

FIG. 2 is a block diagram of the example environment 100 of FIG. 1 in which the redundant software-defined controllers 106a,b discover one another based on a unique partner ID assigned to both redundant software-defined controllers 106a, b (e.g., based on the unique partner ID generated by the host management client 108 as discussed above in connection with FIG. 1). The host services 114a,b use commands from respective libraries to write the unique partner ID received from the host management client 108 to filesystems 202a, 202b (e.g., guest VM filesystems) of the primary and secondary software-defined controllers 106a, b via corresponding VMBuses of the hosts 104a, b.

After the unique partner ID is written to the filesystems 202a, b and the redundant software-defined controllers 106a, b are brought online (e.g., are instantiated), example controller services 204a, 204b (e.g., software-defined controller apps) of the redundant software-defined controllers 106a, b access and use their instances of the unique partner ID in their respective filesystems 202a, b. The redundant software-defined controllers 106a, b broadcast corresponding “who's there” discovery packets on a network to discover one another amongst multiple potential partners running on any number of hosts on the network. When the software-defined controller 106a, b receives a response, it is from the other software-defined controller 106a, b having the same unique partner ID. The software-defined controllers 106a, b then pair or bond and synchronize their information (e.g., controller type, media access control (MAC) address, etc.) with one another.

After the software-defined controllers 106a, b find one another and complete a pairing or bonding process, the software-defined controllers 106a, b can be connected to field devices (e.g., sensors, valves, pumps, mixers, etc.) in a control system to monitor process parameters and/or send commands to field devices to control different aspects of the process.

Examples disclosed herein enable upgrading or updating one software-defined controller 106a, b without triggering a duplication event on the other one of the software-defined controllers 106a, b. Not triggering such a duplication event is advantageously used to prevent both redundant software-defined controllers 106a, b from simultaneously going offline for the upgrade/update event. This substantially ensures that a process system is under the control of at least one of the software-defined controllers 106a, b at any given time. Examples disclosed herein provide a way to update an inactive (e.g., standby) one of the redundant software-defined controllers 106a, b while the active one of the redundant software-defined controllers 106a, b continues to control the process system without simultaneously updating. After the update to the standby redundant software-defined controller 106a, b, the updated controller can assume active control while the yet-to-be-updated redundant software-defined controller 106a, b is transitioned to inactive (e.g., standby) mode and subsequently updated. In other words, in examples disclosed herein, upgrading/updating is done by deleting an existing software-defined controller 106a, b that is in standby mode, spinning up a new, replacement software-defined controller with new software, and pairing the new, replacement software-defined controller with the active one of the software-defined controllers 106a, b. The upgraded/updated software-defined controller may be spun up on the same host hardware or on another host.

In examples disclosed herein, the redundant software-defined controllers 106a, b are independent of one another and each stays in an active role or a standby role based on various conditions. As such, when in an active mode, the active one of the redundant software-defined controllers 106a, b operates differently from the one of the redundant software-defined controllers 106a, b that is in standby mode. The program code running in the active one of the redundant software-defined controllers 106a, b runs differently from the program code running in the standby one of the redundant software-defined controllers 106a, b. For example, the standby one of the redundant software-defined controllers 106a, b listens for whether the active one of the redundant software-defined controllers 106a, b is still running and determines whether it has the same configuration as the active one of the redundant software-defined controllers 106a, b. In examples disclosed herein, the active and standby ones of the redundant software-defined controllers 106a, b are not simultaneously actively running the same program code at the same time to update their states simultaneously. In examples disclosed herein, the active and standby ones of the redundant software-defined controllers 106a, b synchronize state between one another to share their configurations. This ensures they can run the same active program code when either is switched to the active role.

Upon bootup, the redundant software-defined controllers 106a, b negotiate which will be in active mode and which will be in standby mode. In some examples, it is not predetermined which of the redundant software-defined controllers 106a, b assumes which role. In some examples, the redundant software-defined controller 106a, b to boot up first may take on the active role first. During operation, heartbeat messages are exchanged between the redundant software-defined controllers 106a, b. The heartbeat messages are notifications that the redundant software-defined controllers 106a, b are operating as expected. The standby one of the redundant software-defined controllers 106a, b maintains data connections with field device I/Os so that it is receiving field device updates while in standby mode. The standby one of the redundant software-defined controllers 106a, b remains in standby mode until it no longer receives a heartbeat message from the active one of the redundant software-defined controllers 106a, b. Upon not receiving heartbeat messages from the active one of the redundant software-defined controllers 106a, b, the standby one of the redundant software-defined controllers 106a, b determines that the active one of the redundant software-defined controllers 106a, b has failed, and the standby one of the redundant software-defined controllers 106a, b switches to active mode.

The client machine 102, the hosts 104a, b, and components thereof of FIGS. 1 and 2 may be instantiated (e.g., creating an instance of, bring into being for any length of time, materialize, implement, etc.) by corresponding programmable circuitry. For example, programmable circuitry for each of the client machine 102 and the hosts 104a, b, and components thereof may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, each of the client machine 102 and the hosts 104a, b, and components thereof may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions associated with at least one of the client machine 102, the hosts 104a, b, and/or components thereof. It should be understood that some or all of the circuitry of FIGS. 1 and 2 may be instantiated at the same or different times. Some or all of the circuitry may be instantiated, for example, in one or more threads executing concurrently on hardware and/or in series on hardware. Moreover, in some examples, some or all of the circuitry of FIGS. 1 and 2 may be implemented by microprocessor circuitry executing instructions and/or FPGA circuitry performing operations to implement one or more virtual machines and/or containers.

While an example manner of implementing the client machine 102, the hosts 104a, b, and components thereof of FIGS. 1 and 2 is illustrated in FIGS. 1 and 2, one or more of the elements, processes, and/or devices illustrated in FIGS. 1 and 2 may be combined, divided, re-arranged, omitted, eliminated, and/or implemented in any other way. Further, the client machine 102, the hosts 104a, b, and/or components thereof of FIGS. 1 and 2, may be implemented by hardware alone or by hardware in combination with software and/or firmware. Thus, for example, any of the client machine 102, the hosts 104a, b, and/or components thereof of FIGS. 1 and 2, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example client machine 102, the hosts 104a, b, and/or components thereof of FIGS. 1 and 2 may include one or more elements, processes, and/or devices in addition to, or instead of, those illustrated in FIGS. 1 and 2, and/or may include more than one of any or all of the illustrated elements, processes and devices.

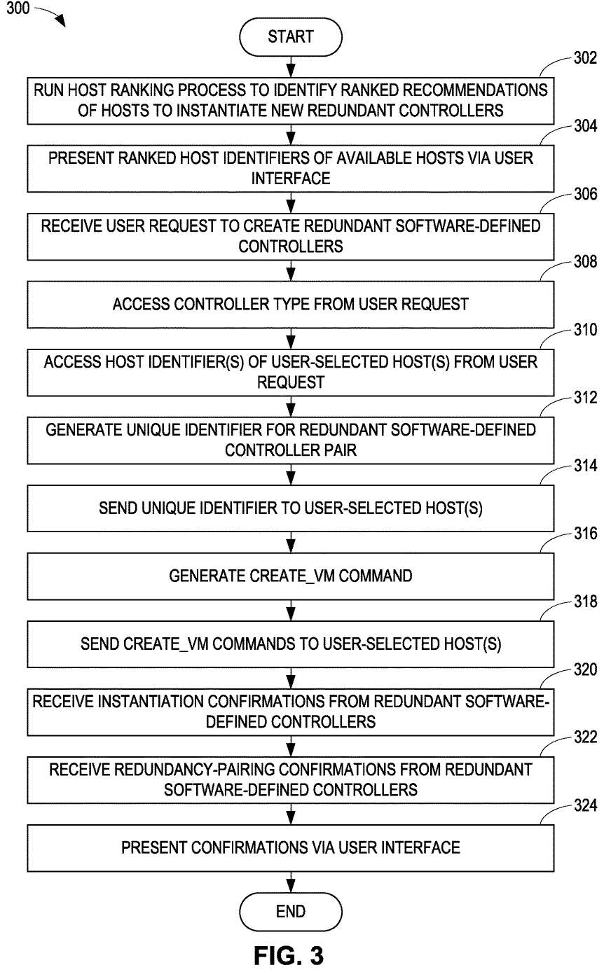

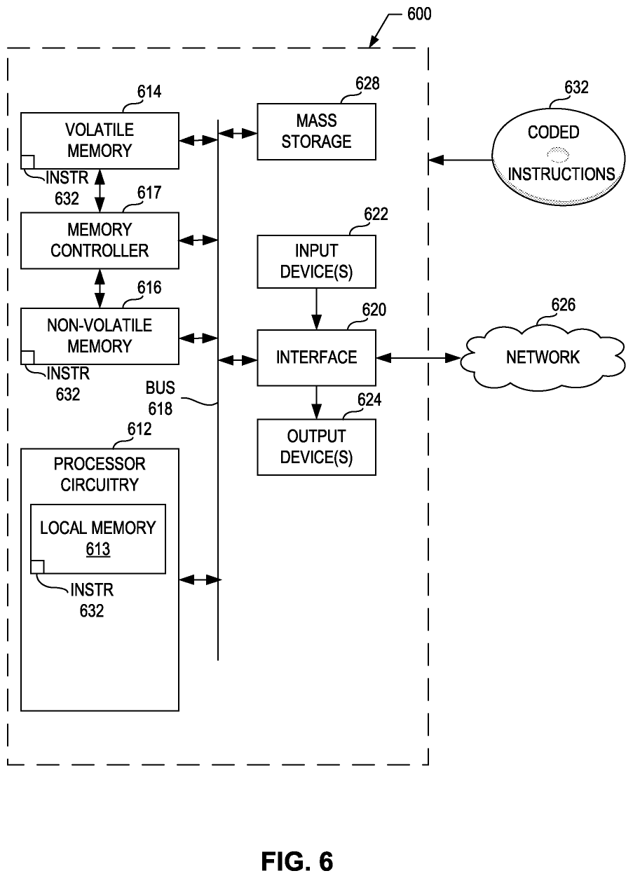

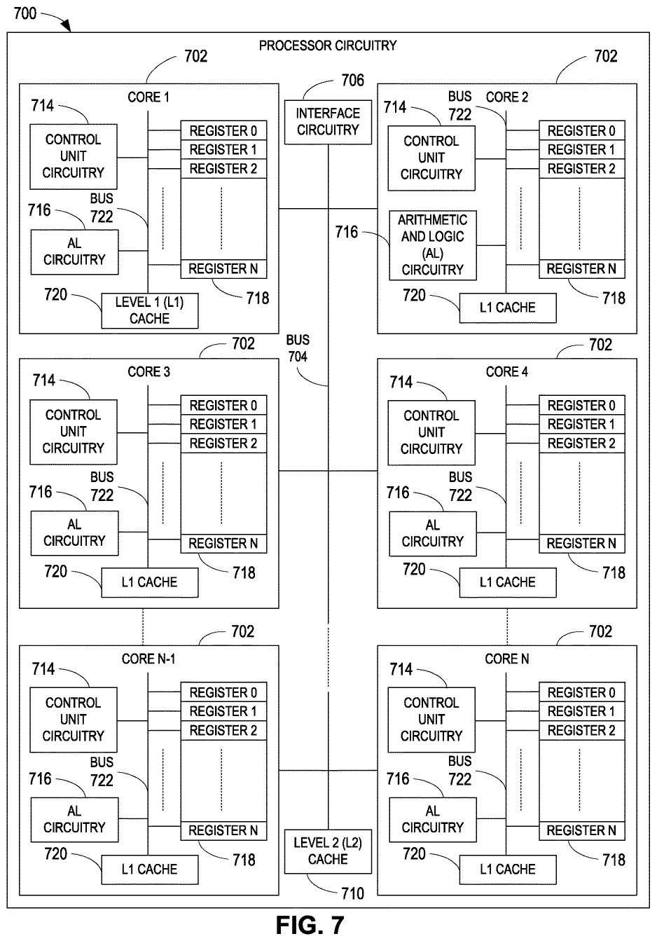

Flowcharts representative of example machine-readable instructions, which may be executed by programmable circuitry to implement and/or instantiate the client machine 102, the hosts 104a, b, and/or components thereof of FIGS. 1 and 2 and/or representative of example operations which may be performed by programmable circuitry to implement and/or instantiate the client machine 102, the hosts 104a, b, and/or components thereof of FIGS. 1 and 2, are shown in FIGS. 3-5. The machine-readable instructions may be one or more executable program(s) or portion(s) of one or more executable program(s) for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine-readable instructions cause an operation, a task, etc., to be carried out and/or performed in an automated manner in the real world. As used herein, “automated” means without human involvement.

The program(s) may be embodied in instructions (e.g., software and/or firmware) stored on one or more non-transitory computer readable and/or machine-readable storage media such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, read-only memory (ROM), a solid-state drive (SSD), SSD memory, non-volatile memory (e.g., electrically erasable programmable ROM (EEPROM), flash memory, etc.), volatile memory (e.g., Random Access Memory (RAM) of any type, etc.), and/or any other storage device or storage disk. The non-transitory computer readable storage medium may include one or more mediums and/or types of mediums. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or may be embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Additionally or alternatively, any or all of the blocks of the flowcharts may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform corresponding operations without executing software or firmware.

Although the example program(s) is/are described with reference to the flowcharts illustrated in FIGS. 3-5, many other methods of implementing the example client machine 102, the hosts 104a, b, and/or components thereof of FIGS. 1 and 2 may alternatively be used. For example, the order of execution of the blocks of the flowcharts may be changed, and/or some of the blocks described may be changed, eliminated, or combined.

The machine-readable instructions may be distributed across multiple hardware devices and/or executed by two or more hardware devices (e.g., a server and a client hardware device). The programmable circuitry may be distributed in different network locations and/or may be local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine-readable instructions described herein can be written or represented using any suitable previously developed or future-developed instruction language, scripting language, programming language, etc. including, for example, C, C++, Java, C-Sharp, Perl, Python, JavaScript, HyperText Markup Language (HTML), Structured Query Language (SQL), Swift, etc.

As mentioned above, the example operations of FIGS. 3-5 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 3 is a flowchart representative of example machine-readable instructions and/or example operations 300 that may be executed, instantiated, and/or performed by example programmable circuitry to implement the client machine 102 of FIG. 1 to instantiate the redundant software-defined controllers 106a, b in one or more host(s) (e.g., the hosts 104a, b). The example machine-readable instructions and/or the example operations 300 of FIG. 3 begin at block 302, at which the host management service 112 runs a host ranking process to identify ranked recommendations of hosts to instantiate new software-defined controllers. At block 304, the host management client 108 presents ranked host identifiers of available hosts via a user interface of the client machine 102. For example, the ranked host identifiers are based on the host ranking process performed at block 302. At block 306, the host management client 108 receives a user request to create redundant software-defined controllers. For example, a user may submit such a request via the user interface of the client machine 102.

At block 308, the host management service 112 accesses a controller type from the user request. For example, the controller type corresponds to the type of functionality that the requested redundant software-defined controllers are to implement. Example types of functionality correspond to types of field devices that will be monitored and/or controlled, types of communication protocols, number of input/output (I/O) ports, etc.

At block 310, the host management service 112 accesses host identifier(s) of user-selected host(s) from the user request. In some examples, the user may select a single host in which to instantiate both of the redundant software-defined controllers 106a, b. However, to increase availability of the redundant software-defined controllers 106a, b, the user may select two separate hosts, such as the hosts 104a, b, to instantiate corresponding ones of the redundant software-defined controllers 106a, b. Accordingly, should one host 104a, b experience hardware failure, the other host 104a, b can continue hosting the other one of the redundant software-defined controllers 106a, b as part of a failover strategy.

At block 312, the host management service 112 generates a unique partner ID for the pair of the redundant software-defined controllers 106a, b. At block 314, the host management service 112 sends the unique partner ID to user-selected hosts 104a, b. For example, the host management service 112 sends the unique partner ID to user-selected hosts 104a, b as part of a VmItem object. At block 316, the host management service 112 generates a create_VM command (e.g., a CreateVM command). For example, the create_VM command is to cause the hosts 104a, b to instantiate VMs and run corresponding ones of the redundant software-defined controllers 106a, b. To instantiate VMs and the redundant software-defined controllers 106a, b based on user-specified criteria, the host management service 112 adds corresponding configuration parameters in the create_VM command for use by the hosts 104a, b to configure the VMs and the redundant software-defined controllers 106a, b. At block 318, the host management service 112 sends separate ones of the create_VM command to the user-selected hosts 104a, b. In some examples, the unique partner ID is included as metadata contained in the create-VM command sent to each of the user-selected hosts 104a, b. In some such examples, block 314 is omitted.

At block 320, the host management service 112 receives instantiation confirmations from the software-defined controllers 106a, b. For example, after the hosts 104a, b instantiate VMs and corresponding ones of the software-defined controllers 106a, b, the software-defined controllers 106a, b can send respective notifications to the host management service 112 informing the host management service 112 that they are successfully instantiated and running.

At block 322, the host management service 112 receives redundancy-pairing confirmations from the software-defined controllers 106a, b. For example, after the software-defined controllers 106a, b autonomously discover one another and pair or bond with one another (e.g., without intervention by the host management service 112 of the client machine 102), the software-defined controllers 106a, b can send respective notifications to the host management service 112 notifying the host management service 112 of their successful pairing. At block 324, the host management client 108 presents confirmations of the instantiations and pairing of the software-defined controllers 106a, b via the user interface of the client machine 102. The instructions and/or operations 300 of FIG. 3 end.

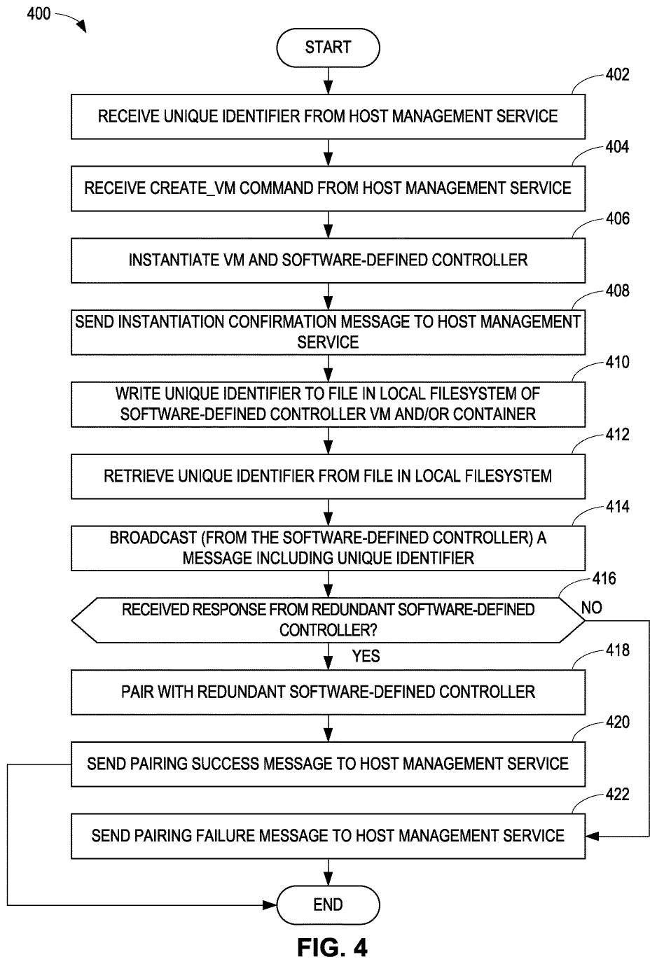

FIG. 4 is a flowchart representative of example machine-readable instructions and/or example operations 400 that may be executed, instantiated, and/or performed by example programmable circuitry to implement the hosts 104a, b of FIGS. 1 and 2 to instantiate and pair the redundant software-defined controllers 106a, b. The example machine-readable instructions and/or the example operations 400 of FIG. 4 are described below relative to the host 104a, the controller 106a, and the host service 114a. However, the same example machine-readable instructions and/or example operations 400 may be similarly used at the host 104b, the controller 106b, and the host service 114b.

The example machine-readable instructions and/or the example operations 400 of FIG. 4 begin at block 402, at which the host service 114a receives a unique partner ID from the host management service 112 of the client machine 102. At block 404, the host service 114a receives a create_VM command from the host management service 112. In some examples, the unique partner ID is contained in or otherwise provided with the create_VM command. At block 406, the host service 114a instantiates a VM and the corresponding software-defined controller 106a in the VM. For example, the host service 114a instantiates the VM and the corresponding software-defined controller 106a based on the create_VM command.

At block 408, the host service 114a sends an instantiation confirmation message to the host management service 112. At block 410, the host service 114a writes the unique partner ID to a file in the local filesystem 202a of the software-defined controller 106a VM and/or container. At block 412, the controller service 204a of the software-defined controller 106a retrieves the unique partner ID from the file in the local filesystem 202a. At block 414, the controller service 204a of the software-defined controller 106a broadcasts a discovery message including the unique partner ID on the network to which the host 104a is connected. For example, the controller service 204a autonomously broadcasts a “who's there” discovery packet on the network (e.g., without intervention by the host management service 112 of the client machine 102) to discover the other software-defined controller 106b amongst multiple potential partners running on any number of hosts on the network.

At block 416, the controller service 204a determines whether it has received a response message from the other redundant software-defined controller 106b. If the controller service 204a determines that it has not received a response message from the other redundant software-defined controller 106b (block 416: No), control advances to block 422 at which the controller service 204a sends a pairing failure message to host management service 112 and the instructions and/or operations 400 of FIG. 4 end. Alternatively, instead of or in addition to sending a pairing failure message, the controller service 204a configures the software-defined controller 106a to operate in a simplex controller mode with no partner (e.g., without the redundant software-defined controller 106a).

If the controller service 204a determines that it has received a response message from the other redundant software-defined controller 106b (block 416: Yes), the software-defined controller 106a of the host 104a pairs or bonds with the other redundant software-defined controller 106b at the other host 104b (block 418). For example, the software-defined controller 106a autonomously pairs or bonds with the other redundant software-defined controller 106b through handshake communications with the redundant software-defined controller 106b (e.g., without intervention by the host management service 112 of the client machine 102). In some examples, the software-defined controllers 106a, b also use such handshake communications to autonomously negotiate which of the controllers is to assume the active role and which assumes the standby role. At block 420, the controller service 204a sends a pairing success message to the host management service 112. The instructions and/or operations 400 of FIG. 4 end.

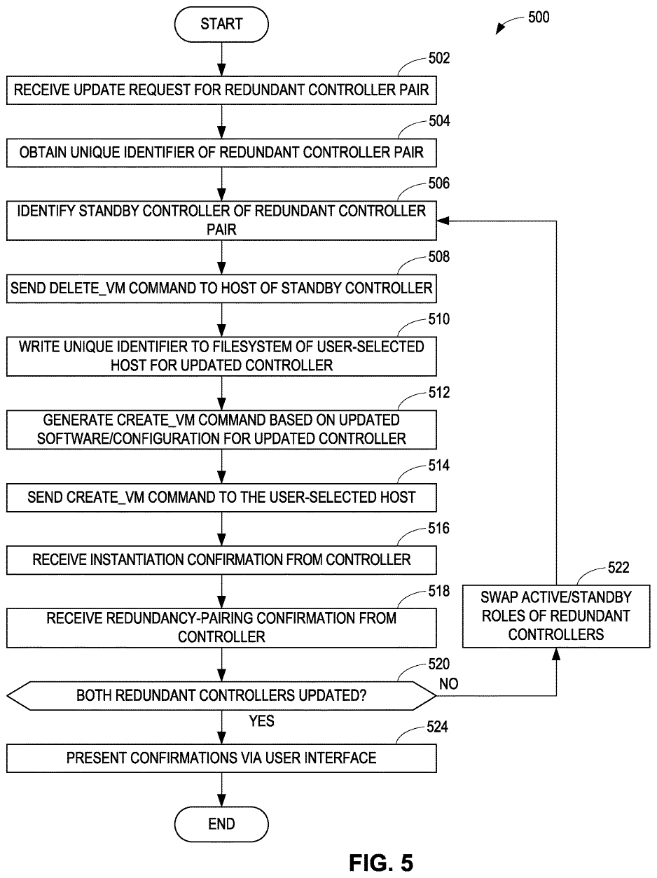

FIG. 5 is a flowchart representative of example machine-readable instructions and/or example operations 500 that may be executed, instantiated, and/or performed by example programmable circuitry to implement the client machine 102 of FIG. 1 to update the redundant software-defined controllers 106a, b. The example machine-readable instructions and/or the example operations 500 of FIG. 5 begin at block 502, at which the host management client 108 receives an update/upgrade request for the redundant software-defined controllers 106a, b. For example, the update/upgrade request may be submitted by a user via the user interface of the client machine 102 and received by the host management client 108.

At block 504, the host management service 112 obtains a unique partner ID of the redundant software-defined controllers 106a, b from the update/upgrade request. At block 506, the host management service 112 identifies which one of the software-defined controllers 106a, b is in a standby mode. At block 508, the host management service 112 sends a delete_VM command to the host 104a, b of the software-defined controller 106a, b that is in the standby mode.

At block 510, the host management service 112 writes the unique partner ID to the filesystem of a user-selected host that is to instantiate an updated/upgraded software-defined controller. For example, a user may use the user interface of the client machine 102 to select a different host (or the same host 104a, b) to host the updated/upgraded software-defined controller. In some examples, the host management service 112 writes the unique partner ID to the filesystem of the user-selected host using a VmItem object. At block 512, the host management service 112 generates a create_VM command based on the updated software/configuration for the updated/upgraded software-defined controller.

At block 514, the host management service 112 sends the create_VM command to the user-selected host. At block 516, the host management service 112 receives an instantiation confirmation notification from the updated/upgraded software-defined controller. For example, after the user-selected host instantiates a VM and the updated/upgraded software-defined controller based on the create_VM command of block 514, the updated/upgraded software-defined controller sends the instantiation confirmation notification to the client machine 102 to inform the host management service 112 that it is instantiated and running.

At block 518, the host management service 112 receives a redundancy-pairing confirmation notification from the updated/upgraded software-defined controller. For example, after the updated/upgraded software-defined controller autonomously discovers the active one of the software-defined controllers 106a, b and pairs or bonds with the active one of the software-defined controllers 106a, b (e.g., without intervention by the host management service 112 of the client machine 102), the updated/upgraded software-defined controller sends a redundancy-pairing confirmation notification to the host management service 112 notifying the host management service 112 of the successful pairing. At this point, the newly updated/upgraded software-defined controller is in the standby mode.

At block 520, the host management service 112 determines whether both redundant software-defined controllers are updated. If the host management service 112 determines that at least one of the redundant software-defined controllers is not yet updated (block 520: No), control advances to block 522 at which the host management service 112 swaps active and standby roles of the redundant software-defined controllers. For example, the host management service 112 sends a mode command to the newly updated/upgraded software-defined controller to enter the active mode and sends a mode command to the yet-to-be-updated software-defined controller to enter the standby mode. Control then returns to block 506, and the instructions and/or operations of blocks 506, 508, 510, 512, 514, 516, and 518 are repeated to update/upgrade the yet-to-be-updated software-defined controller.

When the host management service 112 determines that both redundant software-defined controllers are updated (block 520: Yes), control advances to block 524, at which the host management client 108 presents confirmations via a user interface of the client machine 102. For example, the host management client 108 presents the confirmations of blocks 516 and 518 via the user interface. Alternatively, if the update/upgrade process does not complete successfully, the host management client 108 presents alert notifications via the user interface to inform a user of the incomplete update/upgrade process. The example instructions and/or operations 500 end.

FIG. 6 is a block diagram of an example programmable circuitry platform 600 structured to execute and/or instantiate the example machine-readable instructions and/or the example operations of FIGS. 3-5 to implement the client machine 102, the hosts 104a, b, and/or components thereof of FIGS. 1 and 2. For example, separate instances of the programmable circuitry platform 600 can be used to implement separate ones of the client machine 102 and the hosts 104a, b. The programmable circuitry platform 600 can be, for example, a server, a personal computer, a workstation, a self-learning machine (e.g., a neural network), a mobile device (e.g., a cell phone, a smart phone, a tablet such as an iPad™), an Internet appliance, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, VPUs, XPUs, and/or microcontrollers from any desired family or manufacturer. The programmable circuitry 612 may be implemented by one or more semiconductor based (e.g., silicon based) devices.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or a speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 632, which may be implemented by the machine-readable instructions of FIGS. 3-5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 and/or components thereof may include additional and/or alternate structures to those shown and described below. The microprocessor 700 is a semiconductor device fabricated to include transistors interconnected to implement the structures described below in one or more integrated circuits (ICs) contained in one or more packages.

The microprocessor 700 executes machine-readable instructions of the flowcharts of FIGS. 3-5 to instantiate the circuitry of FIGS. 1 and 2 as logic circuits to perform operations corresponding to those machine-readable instructions. In some such examples, the circuitry of FIGS. 1 and 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine-readable instructions. For example, machine code corresponding to a firmware program, an embedded software program, or a software program represented by the flowcharts of FIGS. 3-5 may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 3-5.

The cores 702 may communicate by a first example bus 704. In some examples, the first bus 704 may be implemented by a communication bus to effectuate communication associated with one(s) of the cores 702. For example, the first bus 704 may be implemented by any suitable bus technology (e.g., an Inter-Integrated Circuit (I2C) bus, a Serial Peripheral Interface (SPI) bus, a PCI bus, a PCIe bus, etc.). Additionally or alternatively, the first bus 704 may be implemented by any other type of computing or electrical bus. The cores 702 may obtain data, instructions, and/or signals may be communicated (e.g., accessed, obtained, output, provided, etc.) between the cores 702 and one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an arithmetic logic unit (ALU)) 716, a plurality of registers 718 (e.g., hardware registers), the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 performs one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

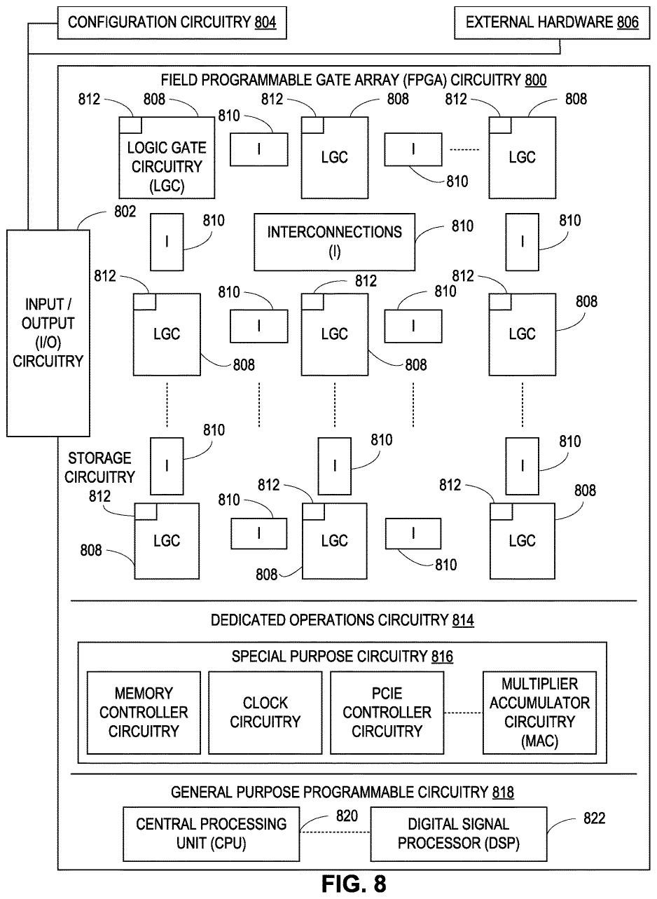

FIG. 8 is a block diagram of another example implementation of the programmable circuitry 612 of FIG. 6. In this example, the programmable circuitry 612 is implemented by FPGA circuitry 800. Programmable logic circuitry of the FPGA circuitry 800 may be programmed to create dedicated logic circuits that perform operations and/or functions represented in the flowcharts of FIGS. 3-5. For example, the FPGA circuitry 800 includes interconnections and logic circuitry (e.g., logic gates, switches, etc.) that may be configured, structured, programmed, and/or interconnected in different ways to instantiate some or all of the operations/functions corresponding to the machine-readable instructions represented by the flowcharts of FIGS. 3-5. After an FPGA programming process, the FPGA circuitry 800 instantiates the operations and/or functions corresponding to the machine-readable instructions in hardware. In some examples, the FPGA circuitry 800 can execute the operations/functions faster than they could be performed by a general-purpose microprocessor.

Specifically, in contrast to the microprocessor 700 of FIG. 7 described above (which is a general purpose device that may be programmed to execute some or all of the machine readable instructions represented by the flowchart(s) of FIGS. 3-5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5.

As such, the FPGA circuitry 800 may be configured and/or structured to effectively instantiate some or all of the operations/functions corresponding to the machine readable instructions of the flowchart(s) of FIGS. 3-5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 3-5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine-readable instructions of FIGS. 3-5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 that execute(s) a first portion of the machine-readable instructions represented by the flowcharts of FIGS. 3-5 to perform first operation(s)/function(s), and/or include the FPGA circuitry 800 of FIG. 8 configured and/or structured to perform second operation(s)/function(s) corresponding to a second portion of the machine-readable instructions represented by the flowcharts of FIGS. 3-5, and/or include an ASIC configured and/or structured to perform third operation(s)/function(s) corresponding to a third portion of the machine-readable instructions represented by the flowcharts of FIGS. 3-5.

It should be understood that some or all of the circuitry corresponding to the client machine 102, the hosts 104a, b, and/or components thereof of FIGS. 1 and 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry corresponding to the client machine 102, the hosts 104a, b, and/or components thereof of FIGS. 1 and 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of the client machine 102, the hosts 104a, b, and/or components thereof of FIGS. 1 and 2 may be implemented within one or more virtual machines and/or containers executing on the microprocessor 700 of FIG. 7.

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

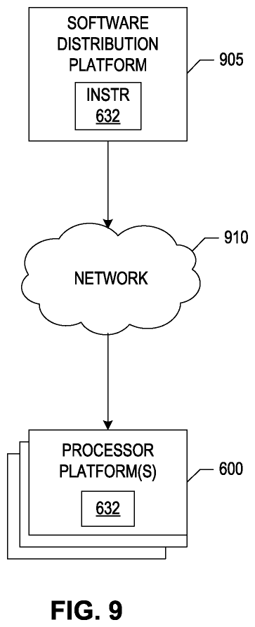

A block diagram illustrating an example software distribution platform 905 to distribute software such as the example machine-readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine-readable instructions 632, which may correspond to the example machine-readable instructions of FIGS. 3-5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 3-5, may be downloaded to the example programmable circuitry platform 600, which is to execute the machine readable instructions 632 to implement the client machine 102, the hosts 104a, b, and/or components thereof of FIGS. 1 and 2. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

From the foregoing, it will be appreciated that example systems, apparatus, articles of manufacture, and methods have been disclosed that implement redundant software-defined controllers in control systems. Disclosed systems, apparatus, articles of manufacture, and methods improve the efficiency of using a computing device and/or network computing devices by: implementing redundant software-defined controllers without a physical redundancy link in the backplane of a physical carrier device; implementing software-defined controllers using a unique partner ID to identify controller partners across hosts when many controllers are running in multiple hosts on a network; implementing software that manages hosts by writing unique partner IDs into filesystems of software-defined controllers via VMBuses; implementing software-defined controllers that can read and use their unique partner ID to discover their partners over a network in a distributed manner; enabling redundant software-defined controllers to be used in control systems in place of simplex software-defined controllers; and implementing redundant software-defined controllers that are flexible to allow scaling to any number of hosts and software-defined controllers in those hosts. Disclosed systems, apparatus, articles of manufacture, and methods are accordingly directed to one or more improvement(s) in the operation of a machine such as a computer, a control system of multiple machines/devices, or other electronic and/or mechanical devices.

Further examples and combinations thereof include the following:

Example 1 includes an apparatus comprising interface circuitry, machine readable instructions, and programmable circuitry to at least one of instantiate or execute the machine readable instructions to send a partner identifier to first and second hosts in a network, send a first command to the first host to create a first software-defined controller for a control system, and send a second command to the second host to create a second software-defined controller for the control system, the first and second software-defined controllers to discover one another and pair with one another based on the partner identifier.

Example 2 includes the apparatus of example 1, wherein the programmable circuitry is to cause presentation of a confirmation indicative of pairing of the first and second software-defined controllers with one another.

Example 3 includes the apparatus of any one or more of examples 1-2, wherein there is no physical dedicated redundancy link between the first and second hosts in a backplane of a physical carrier to connect the first and second software-defined controllers.

Example 4 includes the apparatus of any one or more of examples 1-3, wherein the programmable circuitry is to identify the first and second hosts from a plurality of hosts based on availability of resources of the first and second hosts relative to other hosts in the plurality of hosts.

Example 5 includes the apparatus of any one or more of examples 1-4, wherein the partner identifier is to be sent to the first host as metadata contained in the first command, and the partner identifier is to be sent to the second host as metadata contained in the second command.

Example 6 includes the apparatus of any one or more of examples 1-5, wherein the first and second software-defined controllers are to automatically establish, based on the pairing with one another, the first software-defined controller as an active controller and the second software-defined controller as a standby controller, the standby controller to be dedicated to take over control of the control system from the active controller in response to the active controller failing.

Example 7 includes the apparatus of example 6, wherein the programmable circuitry is to upgrade the second software-defined controller while the first software-defined controller is operating as the active controller to control the control system, swap active and standby roles of the first and second software-defined controllers, and upgrade the first software-defined controller while the second software-defined controller is operating as the active controller to control the control system.

Example 8 includes the apparatus of example 7, wherein the programmable circuitry is to upgrade the second software-defined controller by deleting a current instance of the second software-defined controller, and sending a third command to either the second host or a third host to create a new instance of the second software-defined controller, the new instance of the second software-defined controller updated relative to the current instance of the second software-defined controller.

Example 9 includes the apparatus of any one or more of examples 1-8, wherein the first and second software-defined controllers are to synchronize a state between one another to share their configurations when they pair with one another.

Example 10 includes a non-transitory machine readable storage medium comprising instructions to cause programmable circuitry to at least send a partner identifier to first and second hosts in a network, send a first command to the first host to create a first software-defined controller for a control system, and send a second command to the second host to create a second software-defined controller for the control system, the first and second software-defined controllers to discover one another and pair with one another based on the partner identifier.

Example 11 includes the non-transitory machine readable storage medium of example 10, wherein the instructions are to cause the programmable circuitry to cause presentation of a confirmation indicative of pairing of the first and second software-defined controllers with one another.

Example 12 includes the apparatus of any one or more of examples 10-11, wherein there is no physical dedicated redundancy link between the first and second hosts in a backplane of a physical carrier to connect the first and second software-defined controllers.

Example 13 includes the apparatus of any one or more of examples 10-12, wherein the instructions are to cause the programmable circuitry to identify the first and second hosts from a plurality of hosts based on availability of resources of the first and second hosts relative to other hosts in the plurality of hosts.

Example 14 includes the apparatus of any one or more of examples 10-13, wherein the partner identifier is to be sent to the first host as metadata contained in the first command, and the partner identifier is to be sent to the second host as metadata contained in the second command.

Example 15 includes the apparatus of any one or more of examples 10-14, wherein the first and second software-defined controllers are to automatically establish, based on the pairing with one another, the first software-defined controller as an active controller and the second software-defined controller as a standby controller, the standby controller to be dedicated to take over control of the control system from the active controller in response to the active controller failing.

Example 16 includes the non-transitory machine readable storage medium of example 15, wherein the instructions are to cause the programmable circuitry to upgrade the second software-defined controller while the first software-defined controller is operating as the active controller to control the control system, swap active and standby roles of the first and second software-defined controllers, and upgrade the first software-defined controller while the second software-defined controller is operating as the active controller to control the control system.

Example 17 includes the non-transitory machine readable storage medium of example 16, wherein the instructions are to cause the programmable circuitry to upgrade the second software-defined controller by deleting a current instance of the second software-defined controller, and sending a third command to either the second host or a third host to create a new instance of the second software-defined controller, the new instance of the second software-defined controller updated relative to the current instance of the second software-defined controller.

Example 18 includes the apparatus of any one or more of examples 10-17, wherein the first and second software-defined controllers are to synchronize a state between one another to share their configurations when they pair with one another.

Example 19 includes a method comprising sending, by executing instructions with programmable circuitry, a partner identifier to first and second hosts in a network, sending, by executing instructions with the programmable circuitry, a first command to the first host to create a first software-defined controller for a control system, and sending, by executing instructions with the programmable circuitry, a second command to the second host to create a second software-defined controller for the control system, the first and second software-defined controllers to discover one another and pair with one another based on the partner identifier.

Example 20 includes the method of example 19, including receiving a confirmation message indicative of pairing of the first and second software-defined controllers with one another.

Example 21 includes the method of any one or more of examples 19-20, wherein there is no physical dedicated redundancy link between the first and second hosts in a backplane of a physical carrier to connect the first and second software-defined controllers.

Example 22 includes the method of any one or more of examples 19-21, including identifying the first and second hosts from a plurality of hosts based on availability of resources of the first and second hosts relative to other hosts in the plurality of hosts.

Example 23 includes the method of any one or more of examples 19-22, wherein the partner identifier is sent to the first host as metadata contained in the first command, and the partner identifier is sent to the second host as metadata contained in the second command.

Example 24 includes the method of any one or more of examples 19-23, wherein the first and second software-defined controllers automatically establish, based on the pairing with one another, the first software-defined controller as an active controller and the second software-defined controller as a standby controller, the standby controller to be dedicated to take over from the active controller in response to the active controller failing.

Example 25 includes the method of example 24, including upgrading the second software-defined controller while the first software-defined controller is operating as the active controller to control the control system, swapping active and standby roles of the first and second software-defined controllers, and upgrading the first software-defined controller while the second software-defined controller is operating as the active controller to control the control system.

Example 26 includes the method of example 25, wherein the upgrading of the second software-defined controller includes deleting a current instance of the second software-defined controller, and sending a third command to either the second host or a third host to create a new instance of the second software-defined controller, the new instance of the second software-defined controller updated relative to the current instance of the second software-defined controller.

Example 27 includes the method of any one or more of examples 19-26, wherein the first and second software-defined controllers are to synchronize a state between one another to share their configurations when they pair with one another.

Example 28 includes an apparatus comprising interface circuitry, machine readable instructions, and programmable circuitry to at least one of instantiate or execute the machine readable instructions to create a first software-defined controller for a control system in response to a command from a client machine, write a partner identifier to a local filesystem of the first software-defined controller, the partner identifier received from the client machine, cause the first software-defined controller to broadcast a message including the partner identifier over a network to discover a second software-defined controller that was also provided the partner identifier from the client machine, and cause the first software-defined controller to pair with the second software-defined controller.

Example 29 includes the apparatus of example 28, wherein the message is a first message, and the programmable circuitry is to send a second message to the client machine, the second message to at least one of confirm instantiation of the first software-defined controller or confirm the first and second software-defined controllers successfully paired.

Example 30 includes the apparatus of any one or more of examples 28-29, wherein the programmable circuitry is associated with a first host on the network, and the second software-defined controller is implemented by a second host on the network, the first and second software-defined controllers to pair without a physical dedicated redundancy link in a backplane of a physical carrier to connect the first and second hosts.

Example 31 includes the apparatus of any one or more of examples 28-30, wherein the programmable circuitry is to receive the partner identifier as metadata included with the command.

Example 32 includes the apparatus of any one or more of examples 28-31, wherein the programmable circuitry is to receive the partner identifier separate from the command.

Example 33 includes the apparatus of any one or more of examples 28-32, wherein the programmable circuitry is to determine which of the first software-defined controller or the second software-defined controller is to be assigned active mode and which is to be assigned standby mode, the determination to be made without intervention of the client machine while the first and second software-defined controllers are pairing.

Example 34 includes the apparatus of any one or more of examples 28-33, wherein the programmable circuitry is to cause the first and second software-defined controllers to, when pairing, synchronize a state between one another to share their configurations.

Example 35 includes a non-transitory machine readable storage medium comprising instructions to cause programmable circuitry to at least create a first software-defined controller for a control system in response to a command from a client machine, write a partner identifier to a local filesystem of the first software-defined controller, the partner identifier received from the client machine, cause the first software-defined controller to broadcast a message including the partner identifier over a network to discover a second software-defined controller that was also provided the partner identifier from the client machine, and cause the first software-defined controller to pair with the second software-defined controller.

Example 36 includes the non-transitory machine readable storage medium of example 35, wherein the message is a first message, and the instructions are to cause the programmable circuitry to send a second message to the client machine, the second message to at least one of confirm instantiation of the first software-defined controller or confirm the first and second software-defined controllers successfully paired.

Example 37 includes the apparatus of any one or more of examples 35-36, wherein the programmable circuitry is associated with a first host on the network, and the second software-defined controller is implemented by a second host on the network, the first and second software-defined controllers to pair without a physical dedicated redundancy link between the first and second hosts.

Example 38 includes the apparatus of any one or more of examples 35-37, wherein the programmable circuitry is to receive the partner identifier as metadata included with the command.

Example 39 includes the apparatus of any one or more of examples 35-38, wherein the programmable circuitry is to receive the partner identifier separate from the command.

Example 40 includes the apparatus of any one or more of examples 35-39, wherein the instructions are to cause the programmable circuitry to determine which of the first software-defined controller or the second software-defined controller is to be assigned active mode and which is to be assigned standby mode, the determination to be made without intervention of the client machine while the first and second software-defined controllers are pairing.

Example 41 includes the apparatus of any one or more of examples 35-40, wherein the instructions are to cause the programmable circuitry to cause the first and second software-defined controllers to, when pairing, synchronize a state between one another to share their configurations.

Example 42 includes a method comprising creating a first software-defined controller for a control system in response to a command from a client machine, writing a partner identifier to a local filesystem of the first software-defined controller, the partner identifier received from the client machine, causing, by executing instructions with programmable circuitry, the first software-defined controller to broadcast a message including the partner identifier over a network to discover a second software-defined controller that was also provided the partner identifier from the client machine, and causing, by executing instructions with the programmable circuitry, the first software-defined controller to pair with the second software-defined controller.

Example 43 includes the method of example 42, wherein the message is a first message, and the method includes sending a second message to the client machine, the second message to at least one of confirm instantiation of the first software-defined controller or confirm the first and second software-defined controllers successfully paired.

Example 44 includes the method of any one or more of examples 42-43, wherein the programmable circuitry is associated with a first host on the network, and the second software-defined controller is implemented by a second host on the network, the first and second software-defined controllers to pair without a physical dedicated redundancy link in a backplane of a physical carrier to connect the first and second hosts.

Example 45 includes the method of any one or more of examples 42-44, including receiving the partner identifier as metadata included with the command.

Example 46 includes the method of any one or more of examples 42-45, including receiving the partner identifier separate from the command.

Example 47 includes the method of any one or more of examples 42-46, including determining which of the first software-defined controller or the second software-defined controller is to be assigned active mode and which is to be assigned standby mode, the determination to be made without intervention of the client machine while the first and second software-defined controllers are pairing.

Example 48 includes the method of any one or more of examples 42-47, wherein the causing of the first and second software-defined controllers to pair includes causing the first and second software-defined controllers to synchronize a state between one another to share their configurations.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
machine readable instructions; and
programmable circuitry to at least one of instantiate or execute the machine readable instructions to:
send a partner identifier to first and second hosts in a network;
send a first command to the first host to create a first software-defined controller for a control system; and
send a second command to the second host to create a second software-defined controller for the control system, the first and second software-defined controllers to discover one another and pair with one another based on the partner identifier.

2. The apparatus of claim 1, wherein the programmable circuitry is to cause presentation of a confirmation indicative of pairing of the first and second software-defined controllers with one another.

3. The apparatus of claim 1, wherein there is no physical dedicated redundancy link between the first and second hosts in a backplane of a physical carrier to connect the first and second software-defined controllers.

4. The apparatus of claim 1, wherein the programmable circuitry is to identify the first and second hosts from a plurality of hosts based on availability of resources of the first and second hosts relative to other hosts in the plurality of hosts.

5. The apparatus of claim 1, wherein the partner identifier is to be sent to the first host as metadata contained in the first command, and the partner identifier is to be sent to the second host as metadata contained in the second command.

6. The apparatus of claim 1, wherein the first and second software-defined controllers are to automatically establish, based on the pairing with one another, the first software-defined controller as an active controller and the second software-defined controller as a standby controller, the standby controller to be dedicated to take over control of the control system from the active controller in response to the active controller failing.

7. The apparatus of claim 6, wherein the programmable circuitry is to:
upgrade the second software-defined controller while the first software-defined controller is operating as the active controller to control the control system;
swap active and standby roles of the first and second software-defined controllers; and
upgrade the first software-defined controller while the second software-defined controller is operating as the active controller to control the control system.

8. The apparatus of claim 7, wherein the programmable circuitry is to upgrade the second software-defined controller by deleting a current instance of the second software-defined controller, and sending a third command to either the second host or a third host to create a new instance of the second software-defined controller, the new instance of the second software-defined controller updated relative to the current instance of the second software-defined controller.

9. The apparatus of claim 1, wherein the first and second software-defined controllers are to synchronize a state between one another to share their configurations when they pair with one another.

10. A non-transitory machine readable storage medium comprising instructions to cause programmable circuitry to at least:
send a partner identifier to first and second hosts in a network;
send a first command to the first host to create a first software-defined controller for a control system; and
send a second command to the second host to create a second software-defined controller for the control system, the first and second software-defined controllers to discover one another and pair with one another based on the partner identifier.

11. The non-transitory machine readable storage medium of claim 10, wherein the instructions are to cause the programmable circuitry to cause presentation of a confirmation indicative of pairing of the first and second software-defined controllers with one another.

12. The non-transitory machine readable storage medium of claim 10, wherein there is no physical dedicated redundancy link between the first and second hosts in a backplane of a physical carrier to connect the first and second software-defined controllers.

13. The non-transitory machine readable storage medium of claim 10, wherein the instructions are to cause the programmable circuitry to identify the first and second hosts from a plurality of hosts based on availability of resources of the first and second hosts relative to other hosts in the plurality of hosts.

14. The non-transitory machine readable storage medium of claim 10, wherein the partner identifier is to be sent to the first host as metadata contained in the first command, and the partner identifier is to be sent to the second host as metadata contained in the second command.

15. The non-transitory machine readable storage medium of claim 10, wherein the first and second software-defined controllers are to automatically establish, based on the pairing with one another, the first software-defined controller as an active controller and the second software-defined controller as a standby controller, the standby controller to be dedicated to take over control of the control system from the active controller in response to the active controller failing.

16. The non-transitory machine readable storage medium of claim 15, wherein the instructions are to cause the programmable circuitry to:
upgrade the second software-defined controller while the first software-defined controller is operating as the active controller to control the control system;
swap active and standby roles of the first and second software-defined controllers; and
upgrade the first software-defined controller while the second software-defined controller is operating as the active controller to control the control system.

17. The non-transitory machine readable storage medium of claim 16, wherein the instructions are to cause the programmable circuitry to upgrade the second software-defined controller by deleting a current instance of the second software-defined controller, and sending a third command to either the second host or a third host to create a new instance of the second software-defined controller, the new instance of the second software-defined controller updated relative to the current instance of the second software-defined controller.

18. The non-transitory machine readable storage medium of claim 10, wherein the first and second software-defined controllers are to synchronize a state between one another to share their configurations when they pair with one another.

19. A method comprising:
sending, by executing instructions with programmable circuitry, a partner identifier to first and second hosts in a network;
sending, by executing instructions with the programmable circuitry, a first command to the first host to create a first software-defined controller for a control system; and
sending, by executing instructions with the programmable circuitry, a second command to the second host to create a second software-defined controller for the control system, the first and second software-defined controllers to discover one another and pair with one another based on the partner identifier.

20. The method of claim 19, including receiving a confirmation message indicative of pairing of the first and second software-defined controllers with one another.

21.-48. (canceled)
